(19) United States
(12) Patent Application Publication
(10) Pub. No.: US 2013/0280016 A1
(43) Pub. Date: Oct. 24, 2013

(54) CUTTING DEVICE AND IMAGE FORMING SYSTEM

(71) Applicant: KONICA MINOLTA, INC., Tokyo (JP)

(72) Inventors: Toshio SHIDA, Higashiyamato-shi (JP); Takuya AKABORI, Higashimurayama-shi (JP); Ritsuo FUJII, Hachioji-shi (JP); Masaaki IKEDA, Hachioji-shi (JP); Hitoshi UCHIDA, Kyoto-shi (JP)

(73) Assignee: Konica Minolta, Inc., Tokyo (JP)

(21) Appl. No.: 13/864,824

(22) Filed: Apr. 17, 2013

(30) Foreign Application Priority Data
Apr. 20, 2012 (JP) 2012-096261

(51) Int. Cl. B42C 5/00

(52) U.S. Cl. CPC B42C 5/00
USPC 412/16

(57) ABSTRACT

A cutting device includes a cutting unit and a pre-processing unit. The cutting unit performs fore-edge cutting processing and top-edge/tail-edge cutting processing in a state in which a blade inclines toward a paper surface of a booklet. The fore-edge cutting processing is to cut off a first edge part of the booklet parallel to a spine of the booklet. The top-edge/tail-edge cutting processing is to cut off a second edge part of the booklet perpendicular to the spine. Of the top-edge/tail-edge cutting processing, in first top-edge/tail-edge cutting processing in which the blade cuts the booklet from a side opposite to the spine, before the blade abuts the spine, the pre-processing unit makes a cut at a point of the spine along a cutting direction in which the blade cuts the spine, the point where the blade abuts the spine.

### CROSS REFERENCE TO RELATED APPLICATIONS

The present invention claims priority under 35 U.S.C. §119 to Japanese Application No. 2012-096261 filed Apr. 20, 2012, the entire content of which is incorporated herein by reference.

### BACKGROUND OF THE INVENTION

1. Field of the Invention

The present invention relates to a cutting device and an image forming system.

2. Description of the Related Art

Cutting processing to cut off some edge parts of the booklet is performed in general. Usually, as the cutting processing, fore-edge cutting processing to cut off an edge part of a booklet, the edge part being parallel to the spine of the booklet, and top-edge/tail-edge cutting processing to cut off edge parts of the booklet, the edge parts being perpendicular to the spine of the booklet, are performed. Consequently, three edge parts among four edge parts of a booklet, namely, except for the edge part on the spine side, are cut off.

As a cutting device to perform the above-described cutting processing, there is known a cutting device which performs the cutting processing with respective blades for the three edges. However, in this kind of cutting device, the blade for the fore-edge cutting processing and the blades for the top-edge/tail-edge cutting processing are disposed at right angles to each other. In addition, the cutting device is provided with a mechanism to change a gap between the blades for the top-edge/tail-edge cutting processing in accordance with the size of a booklet. For these reasons and the like, it is unavoidable that the cutting device has a large and/or complicated mechanism. Then, there is known a cutting device which performs both the fore-edge cutting processing and the top-edge/tail-edge cutting processing by changing an orientation of a booklet with respect to a linear blade so as to change a direction in which the booklet is carried toward the blade.

In general, a blade is disposed in such a way as to have a predetermined inclination toward a paper surface of a booklet, and cutting can be smoothly performed owing to the inclination. However, as shown in FIG. 22, if a blade K abuts a booklet B in such a way as to start cutting from a side opposite to a spine H of the booklet B in the top-edge/tail-edge cutting processing, a pressure applied to the booklet B from the blade K generates distortion on the spine H side of the booklet B. Consequently, burrs are generated on the spine H side of a cut surface.

Then, as disclosed in Japanese Patent Application Laid-Open Publication No. 2004-66347 or Japanese Patent Application Laid-Open Publication No. 2011-25368, there is known a cutting device which changes a direction in which a blade inclines so that the blade always starts cutting from the spine side of a booklet in the top-edge/tail-edge cutting processing.

However, the conventional cutting device disclosed in Japanese Patent Application Laid-Open Publication No. 2004-66347 or Japanese Patent Application Laid-Open Publication No. 2011-25368 requires a complicated mechanism to change the direction of the inclination of the blade, and hence the cost is high. In addition, the conventional cutting device requires a space for the mechanism, and hence it is unavoidable that the cutting device is large. Also, the conventional cutting device requires time for a step to change the direction of the inclination of the blade, and hence its productivity is low.

### BRIEF SUMMARY OF THE INVENTION

The present invention is made in view of the circumstances, and objects of the present invention include providing a cutting device and an image forming system each of which can obtain an excellent cut surface including the spine side thereof with a simple mechanism.

In order to achieve at least one of the objects, according to an aspect of the present invention, there is provided a cutting device including: a cutting unit which performs fore-edge cutting processing to cut off a first edge part of a booklet, the first edge part being parallel to a spine of the booklet, and top-edge/tail-edge cutting processing to cut off a second edge part of the booklet, the second edge part being perpendicular to the spine, in a state in which a blade inclines toward a paper surface of the booklet; and a pre-processing unit which, in first top-edge/tail-edge cutting processing of the top-edge/tail-edge cutting processing, the first top-edge/tail-edge cutting processing in which the blade cuts the booklet from a side opposite to the spine, before the blade abuts the spine, makes a cut at a point of the spine along a cutting direction in which the blade cuts the spine, the point where the blade abuts the spine.

Preferably, in the cutting device, the pre-processing unit includes a round blade which abuts the spine so as to make the cut on the spine.

Preferably, in the cutting device, the round blade rotates while abutting the spine along the cutting direction.

Preferably, in the cutting device, the pre-processing unit includes a round-blade drive unit which rotates the round blade.

Preferably, in the cutting device, the pre-processing unit makes a blade which abuts the spine so as to make the cut on the spine reciprocate along the cutting direction.

Preferably, the cutting device further includes a changing unit which changes an orientation of the booklet with respect to the blade so as to change the first edge part and the second edge part to be cut off by the blade depending on which of the fore-edge cutting processing and the top-edge/tail-edge cutting processing is performed.

### BRIEF DESCRIPTION OF THE SEVERAL VIEWS OF THE DRAWING

The present invention is fully understood from the detailed description given hereinafter and the accompanying drawings, which are given byway of illustration only, and thus are not intended to limit the present invention, wherein:

FIG. 1 shows main components of an image forming system in accordance with an embodiment of the present invention;

FIG. 2 is a perspective view of a cutting device;

FIG. 3 is a perspective view of the cutting device at a first rotation angle at which a main body unit exposes blades of a cutting unit on a lateral side;

FIG. 4 is a perspective view of the cutting device at a second rotation angle at which the main body unit exposes the blades of the cutting unit on a lateral side;

FIG. 5 is a perspective view of a carrier unit in the main body unit at a cutting rotation angle;

FIG. 6 is a perspective view of the carrier unit which rotates a booklet and moves the booklet downward from the state shown in FIG. 5;

FIG. 7 is a perspective view of the carrier unit in fore-edge cutting processing;

FIG. 8 is a perspective view of the carrier unit in top-edge/tail-edge cutting processing;

FIG. 9 is an enlarged perspective view of the cutting unit;

FIG. 10A is a block diagram showing a relationship of an orientation of a booklet to a blade in the fore-edge cutting processing;

FIG. 10B is a block diagram showing a relationship of an orientation of the booklet to the blade in first top-edge/tail-edge cutting processing of the top-edge/tail-edge cutting processing, the first top-edge/tail-edge cutting processing in which the blade abuts the booklet from a side opposite to the spine of the booklet;

FIG. 10C is a block diagram showing a relationship of an orientation of the booklet to the blade in second top-edge/tail-edge cutting processing of the top-edge/tail-edge cutting processing, the second top-edge/tail-edge cutting processing in which the blade abuts the booklet from the spine side;

FIG. 11A is a block diagram showing a relationship between an inclination of a blade and an orientation of a booklet in the fore-edge cutting processing;

FIG. 11B is a block diagram showing a relationship between an inclination of the blade and an orientation of the booklet in the first top-edge/tail-edge cutting processing in which the blade abuts the booklet from the side opposite to the spine;

FIG. 11C is a block diagram showing a relationship between an inclination of the blade and an orientation of the booklet in the second top-edge/tail-edge cutting processing in which the blade abuts the booklet from the spine side;

FIG. 12 is a perspective view of a pre-processing unit and components around the pre-processing unit;

FIG. 13 is a block diagram showing a positional relationship between a blade and a round blade;

FIG. 14 is a block diagram of main components related to control of operations of the cutting device;

FIG. 15 is a perspective view showing a state in which the round blade of the pre-processing unit shown in FIG. 12 abuts the spine of a booklet;

FIG. 16 is a perspective view showing a state in which the round blade moves closer to the blade as compared with the state shown in FG. 15;

FIG. 17 is a perspective view showing a state in which the blade is cutting off an edge part of the booklet;

FIG. 18 is a perspective view showing a state in which the blade has cut off the edge part of the booklet;

FIG. 19 is a block diagram of main components of the cutting device provided with a round-blade drive unit which rotates the round blade;

FIG. 20 is a block diagram showing a pointed blade sliding on the spine of a booklet so as to linearly move, the pointed blade having a predetermined inclination toward a paper surface of the booklet which is in a delivery opening;

FIG. 21 is a perspective view of the cutting device provided with a rotation shaft near the center of gravity of the main body unit; and

FIG. 22 shows a situation where distortion is generated on the spine side of a booklet by a pressure applied to the booklet from a blade.

### DETAILED DESCRIPTION OF THE INVENTION

In the following, an embodiment of the present invention is described with reference to the drawings. The embodiment includes various technically-preferred limitations to realize the present invention. However, the scope of the present invention is not limited to the embodiment or the drawings.

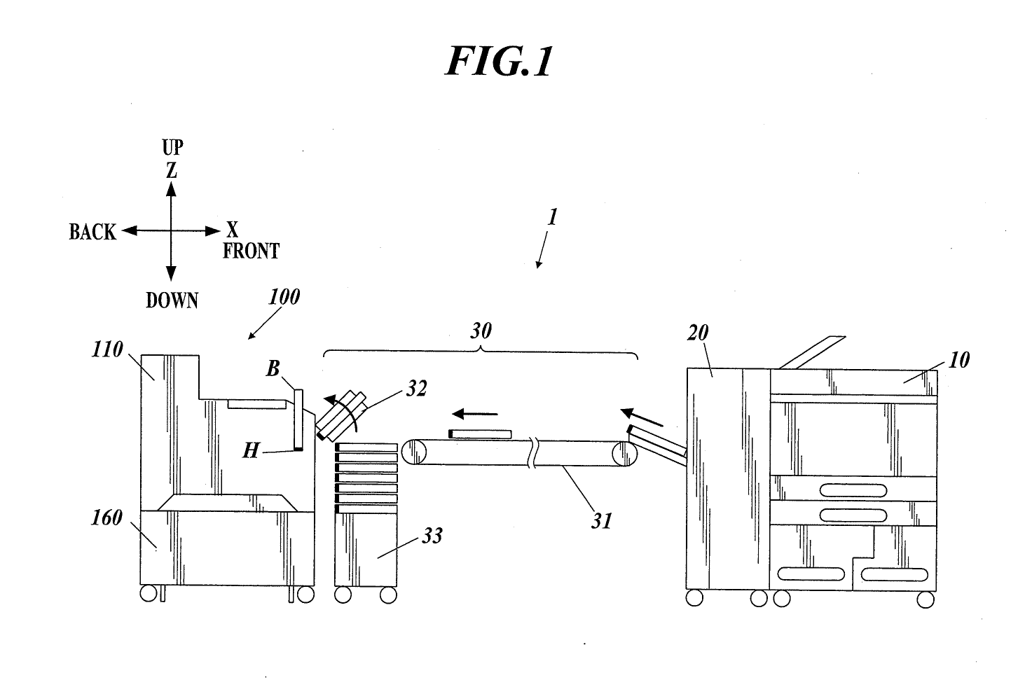

FIG. 1 shows main components of an image forming system 1 in accordance with an embodiment of the present invention.

The image forming system 1 includes an image forming device 10, a paper processing device 20, a carrier device 30 and a cutting device 100.

The image forming device 10 forms images on sheets of paper.

More specifically, the image forming device 10 includes a carrier unit, a developer unit, a primary transfer unit, a secondary transfer unit, a fixation unit and an ejection unit so as to form images on sheets of paper. The carrier unit takes out sheets of paper stored in a paper tray as a recording medium and carries the paper. The developer unit develops toner images corresponding to bitmap data on a primary transfer member such as a transfer roller. The primary transfer unit transfers the toner images developed on the primary transfer member to a secondary transfer member such as a transfer drum. The secondary transfer unit transfers the toner images transferred to the secondary transfer member to the paper carried by the carrier unit. The fixation unit fixes the toner images, which are transferred to the paper, on the paper. The ejection unit ejects the paper on which the toner images are fixed by the fixation unit.

The image forming device 10 delivers the paper on which the images are formed and ejected therefrom to the paper processing device 20.

The paper processing device 20 creates a booklet B from the sheets of the paper on which the images are formed by the image forming device 10.

More specifically, the paper processing device 20 includes a stapling unit, a finishing unit and an ejection unit, for example. The stapling unit staples the sheets of the paper delivered from the image forming device 10 so as to make a booklet B. The finishing unit glues the spine H side of the booklet B, on which the stapling is performed, so as to put a cover, thereby finishing the booklet B. The paper processing device 20 can eject the sheets of the paper delivered from the image forming device 10 without performing the stapling.

The above-described method for creating a booklet B by the paper processing device 20 is an example, and hence not limited thereto. For example, the paper processing device 20 may omit the stapling, and instead glue a spine side of a bundle of sheets and wrap the bundle in a cover so as to create a booklet B.

The carrier device 30 carries booklets B or sheets (a booklet B or booklets B, hereinafter) ejected from the paper processing device 20 to the cutting device 100.

More specifically, for example, as shown in FIG. 1, the carrier device 30 includes a belt conveyer mechanism unit 31, a delivery unit 32 and a standby unit 33, and places booklets B on a belt so as to carry the booklets B from the carrier device 30 to the cutting device 100. The belt conveyer mechanism unit 31 carries booklets B in a predetermined direction. The delivery unit 32 displaces each booklet B in such a way that the paper surfaces thereof are along a vertical direction, the booklet B which is carried by the belt conveyer mechanism unit 31 with the paper surfaces thereof along a horizontal direction, and delivers the booklet B to the cutting device 100. The standby unit 33 puts booklets B on standby until the delivery unit 32 delivers the booklets B to the cutting device 100.

The cutting device 100 performs cutting processing to cut edge parts of booklets B and various types of processing related to the cutting processing.

The image forming system 1 of the embodiment is an image forming system to (i) form images on sheets of paper, (ii) bundle the sheets, on which images are formed, so as to create a booklet B, and (iii) cut off edge parts of the booklet B with the cutting device 100.

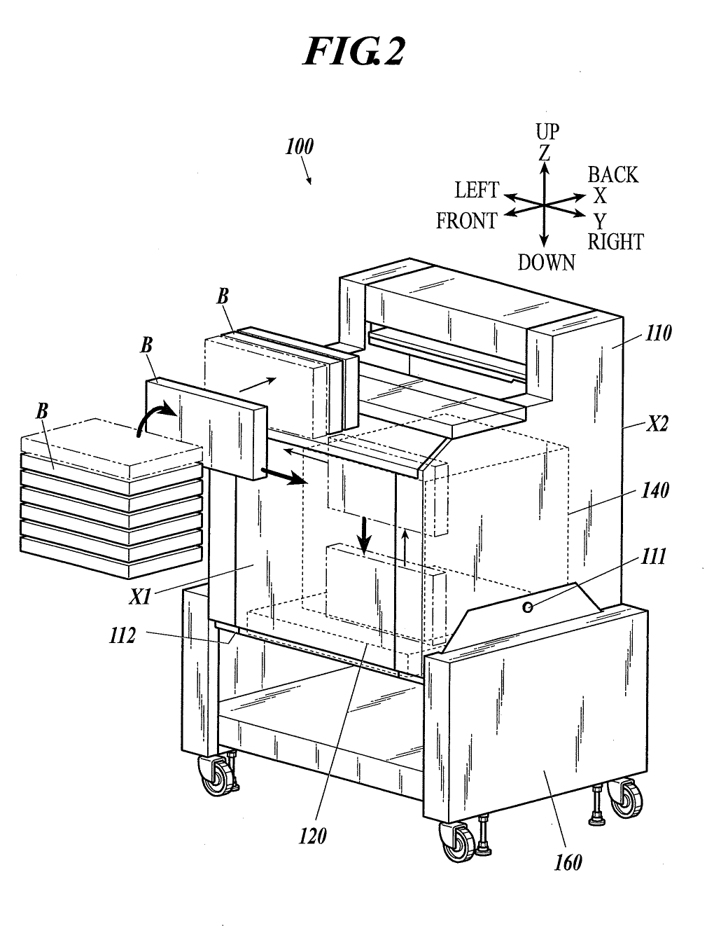

FIG. 2 is a perspective view of the cutting device 100.

The cutting device 100 includes a main body unit 110 and a support unit 160. The main body unit 110 includes a cutting unit 120 and a carrier unit (changing unit) 140. The cutting unit 120 cuts off edge parts of a booklet B. The carrier unit 140 keeps the booklet B carried from the carrier device 30, and carries the booklet B to the cutting unit 120. The support unit 160 supports the main body unit 110 in such a way that the main body unit 110 rotates.

The main body unit 110 is configured to expose blades 121 and 122 of the cutting unit 120 disposed on a lower side (i.e. at a lower part of the main body unit) at least on a lateral side.

In the following, when change of rotation angles of the main body unit 110 is explained, an angle of the main body unit 110 of the cutting device 100 shown in FIG. 2 is regarded as a reference rotation angle. The reference rotation angle of the main body unit 110 shown in FIG. 2 is a rotation angle (cutting rotation angle) at which an edge part of a booklet B is cut off downward by the cutting unit 120. The edge part to be cut off by the cutting unit 120 is made to come out of the main body unit 110 downward.

As shown in FIGS. 1 and 2, the vertical direction is a Z direction, and, of the horizontal direction, a direction along a direction in which booklets B are carried by the belt conveyer mechanism unit 31 of the carrier device 30 to the cutting device 100 is an X direction, and a direction being at right angles to the Z direction and the X direction is a Y direction. In the X direction, a side to which booklets B are carried to the cutting device 100 is the front side, and its opposite side is the back side. The right side and the left side are determined in the Y direction for convenience. Their correspondence relationship is shown in FIGS. 2 to 4.

A lateral surface of the main body unit 110 on the front side and a lateral surface thereof on the back side when the main body unit 110 is at the cutting rotation angle shown in FIG. 2 are a lateral surface X1 and a lateral surface X2, respectively.

As shown in FIG. 2, the support unit 160 supports the main body unit 110 in such a way that the main body unit 110 rotates via a rotation shaft 111 disposed on lateral surfaces of the main body unit 110, the lateral surfaces being at right angles to the lateral surfaces X1 and X2 and a bottom 112. That is, a rotational center axis of the main body unit 110 is along the Y direction.

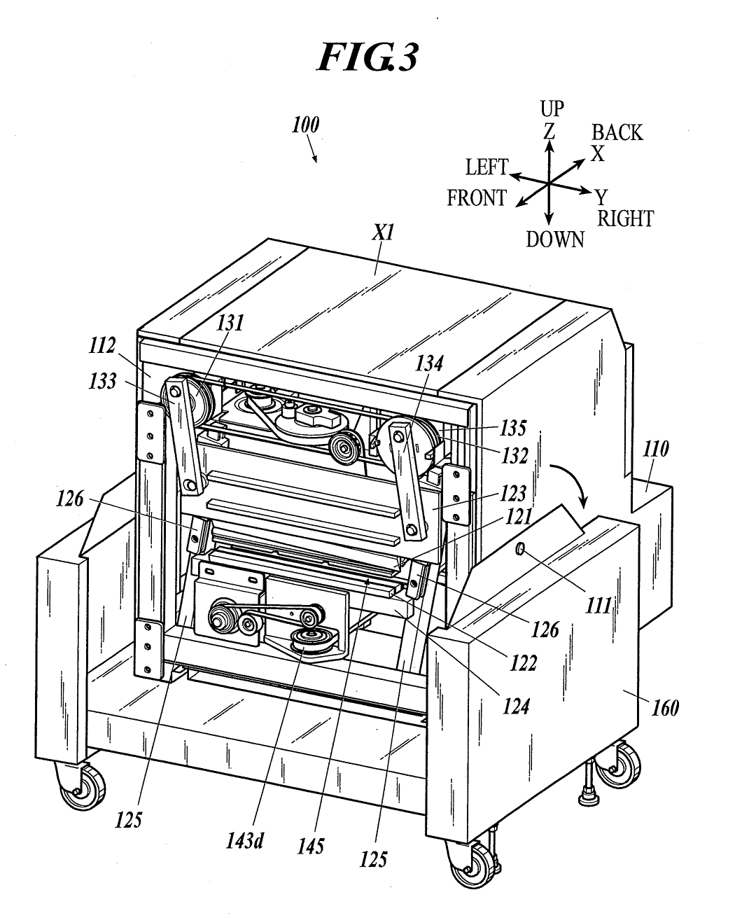

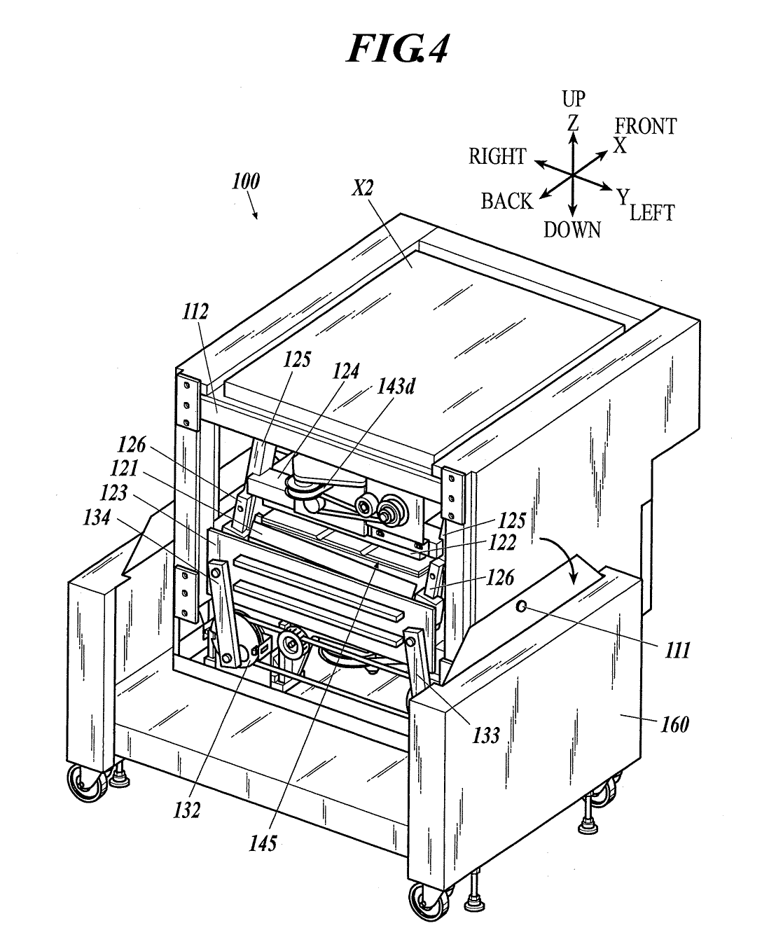

FIGS. 3 and 4 are perspective views each showing the cutting device 100 at a rotation angle at which the main body unit 110 exposes the blades 121 and 122 of the cutting unit 120 on a lateral side. FIG. 3 is a perspective view of the cutting device 100 viewed from the front side while FIG. 4 is a perspective view thereof viewed from the back side.

As shown in FIG. 3, the main body unit 110 rotates in such a way that the lateral surface X1 is positioned on the upper side. The main body unit 110 is in a state in which the blades 121 and 122 of the cutting unit 120 are exposed on a lateral side (front side) at a first rotation angle at which the lateral surface X1 is positioned on the upper side.

As shown in FIG. 4, the main body unit 110 also rotates in such a way that the lateral surface X2 is positioned on the upper side. The main body unit 110 is in a state in which the blades 121 and 122 of the cutting unit 120 are exposed on a lateral side (back side) at a second rotation angle at which the lateral surface X2 is positioned on the upper side.

As shown in FIGS. 3 and 4, the bottom 112 of the main body unit 110 does not have a wall-type cover member, and accordingly is open. Consequently, the components (units and the like) inside the main body unit 110, such as the components of the cutting unit 120, are exposed.

As shown in FIGS. 3 and 4, by rotating the main body unit 110 in such a way that the bottom 112 is positioned on a lateral side (i.e. a lateral side of the cutting device 100), the bottom 112 can be accessed from the lateral side of the cutting device 100. Accordingly, a replacement operation of the blades 121 and 122 of the cutting unit 120 disposed on the lower side at the cutting rotation angle can be performed from the lateral side of the cutting device 100, the lateral side on which the bottom 112 is positioned by the rotation of the main body unit 110.

Here, the cutting unit 120 is described.

The cutting unit 120 includes two blades, namely, the blades 121 and 122, which face each other.

Each of the blades 121 and 122 is a plate-shaped member, the longitudinal direction of which is along the Y direction.

More specifically, each of the blades 121 and 122 is a plate-shaped member disposed along the bottom 112 of the main body unit 110. That is, at the cutting rotation angle shown in FIG. 2, the blades 121 and 122 are along the horizontal direction (an X-Y plane), and at the rotation angles shown in FIGS. 3 and 4, the blades 121 and 122 are along a Y-Z plane.

At least one (the blade 121, for example) of the blades 121 and 122 has a cutting edge at one side of two sides of the blade in the longitudinal direction thereof. The other side of the blade 121 in the longitudinal direction is held by a holding unit 123, and the other side of the blade 122 in the longitudinal direction is held by a holding unit 124.

The holding units 123 and 124 respectively hold the above-described other sides of the blades 121 and 122 in such a way that the blades 121 and 122 are along the bottom 112 of the main body unit 110. The holding units 123 and 124 respectively hold the blades 121 and 122 in such away that the blades 121 and 122 face each other too.

The holding unit 124 is fixed to a predetermine point of the main body unit 110. Accordingly, the blade 122 held by the holding unit 124 is fixed to the predetermined point of the main body unit 110.

The holding unit 123 moves the blade 121 close to and away from the blade 122.

More specifically, on the bottom 112 of the main body unit 110, two prismatic support members 125 disposed along the bottom 112 and parallel to each other are disposed. The holding unit 124 is disposed between the two support members 125, whereby the holding unit 124 forms the shape of “H” on the bottom 112 with the two support members 125.

As shown in FIGS. 3 and 4, the two support members 125 incline toward a direction being at right angles to the lateral surfaces X1 and X2.

On a side (a bottom 112 side) of each of the two support members 125, the side close to (i.e. facing) the bottom 112, a guide rail 126 is disposed. The guide rails 126 are disposed along an extending direction in which the two support members 125 run, and engage with the plate-shaped holding unit 123, which is along the bottom 112, so as to guide movement of the holding unit 123. That is, the holding unit 123 moves along the extending direction of the two support members 125 provided with the guide rails 126.

The holding unit 123 is connected to a blade movement mechanism unit including eccentric cams 131 and 132, connecting members 133 and 134 and a drive unit 135. The connecting members 133 and 134 respectively connect the eccentric cams 131 and 132 to the holding unit 123. The drive unit 135 rotates the eccentric cams 131 and 132. The holding unit 123 moves along the guide rails 126 in response to an operation of the blade movement mechanism unit. Consequently, the blade 121 held by the holding unit 123 moves close to or away from the blade 122 held by the holding unit 124. At the time when the blade 121 is close to the blade 122, the blades 121 and 122 slide, so that an edge part of a booklet B sandwiched between the blades 121 and 122 is cut off.

In each of FIGS. 3 and 4, the bottom 112 of the main body unit 110 is positioned on a lateral side (the front side or the back side). Accordingly, the blades 121 and 122 face the lateral side. However, at the cutting rotation angle shown in FIG. 2, the bottom 112 is positioned on the lower side and along the horizontal direction. Accordingly, the blades 121 and 122 are along the horizontal direction, and a moving direction of the blade 121 is the horizontal direction too. That is, when the main body unit 110 is at the cutting rotation angle shown in FIG. 2, the cutting unit 120 makes an edge part of a booklet B come out of the main body unit 110 downward through the blades 121 and 122 so as to cut off the edge part downward.

As shown in FIG. 2, there is a space between the bottom 112 of the main body unit 110 at the cutting rotation angle and the support unit 160. At the cutting rotation angle, edge parts of booklets B cut off by the cutting unit 120 drop through the space and are piled on the support unit 160. That is, the support unit 160 has a function to accumulate edge parts of booklets B, the edge parts which are cut off to be discarded.

The space between the bottom 112 of the main body unit 110 and the support unit 160 also has a function to prevent the lower ends of the lateral surfaces X1 and X2 of the main body unit 110 from hitting the support unit 160 when the main body unit 110 rotates from the cutting rotation angle as shown in FIGS. 3 and 4.

Replacement of the blades 121 and 122 of the cutting unit 120 with other blades and maintenance of the machine are performed when the cutting device 100 is not in operation. That is, the rotation angles of the main body unit 110 shown in FIGS. 3 and 4, the rotation angles at which the replacement of the blades 121 and 122 can be performed, are rotation angles (no-cutting rotation angle) at which the cutting device 100 is not in operation.

In other words, the main body unit 110 can change the cutting rotation angle and the no-cutting rotation angle, at which the blades 121 and 122 are exposed on a lateral side.

The first rotation angle shown in FIG. 3 and the second rotation angle shown in FIG. 4 are angles to which the main body unit 110 rotates about 90 degrees from the cutting rotation angle shown in FIG. 2 in different directions.

Thus, the cutting device 100 is configured in such a way that the blade 121 faces upward when the main body unit 110 is at the first rotation angle, and the blade 122 faces upward when the main body unit 110 is at the second rotation angle.

Although not being shown, the cutting device 100 is configured in such a way that the upper part of the main body unit 110 at the cutting rotation angle does not go down lower than a position of the upper part thereof at the first rotation angle or the second rotation angle. More specifically, for example, one or both of the lateral surfaces where the rotation shaft 111 is disposed is provided with a projecting unit which projects from the lateral surface to the outside, and when the main body unit 110 rotates and reaches the first rotation angle or the second rotation angle, the projecting unit abuts the support unit 160 so as to stop the main body unit 110. Keeping a rotation angle of the main body unit 110 by the projecting unit is an example, and hence the first rotation angle and the second rotation angle may be kept by another method.

In the case of the first rotation angle shown in FIG. 3, the blade 121 is positioned above the blade 122 and the cutting edge of the blade 121 faces downward while the blade 122 is positioned under the blade 121 and the cutting edge of the blade 122 faces upward.

In the case of the second rotation angle shown in FIG. 4, the blade 121 is positioned under the blade 122 and the cutting edge of the blade 121 faces upward while the blade 122 is positioned above the blade 121 and the cutting edge of the blade 122 faces downward. By replacing the blade 121 with another blade, namely, an unused blade, when, as shown in FIG. 4, the main body unit 110 is at the second rotation angle at which the cutting blade 121 is positioned under the blade 122, the blades 121 and 122 can be replaced with other blades safely.

Furthermore, the rotation angles of the main body unit 110 can be properly used depending on a blade (121 or 122) to be replaced with another blade. Accordingly, the blades 121 and 122 can be replaced with other blades more safely.

Next, the carrier unit 140 is described with reference to FIGS. 5 to 8.

FIGS. 5 to 8 are perspective views each showing the carrier unit 140 in the main body unit 110 at the cutting rotation angle.

The carrier unit (changing unit) 140 includes a sandwiching unit 141, a rotation unit 142 and a linear movement unit 143. The sandwiching unit 141 holds a booklet B delivered from the delivery unit 32 of the carrier device 30. The rotation unit 142 supports the sandwiching unit 141 in such a way that the sandwiching unit 141 rotates. The linear movement unit 143 supports the rotation unit 142 in such a way that the rotation unit 142 linearly moves.

The sandwiching unit 141 includes two sandwiching members 141a and 141b each of which has a surface part which abuts a paper surface of a booklet B. The sandwiching unit 141 is configured in such a way that a distance between the surface parts of the sandwiching members 141a and 141b changes. The two sandwiching members 141a and 141b move close to or away from each other so as to have a distance between the surface parts, the distance corresponding to the thickness of a booklet B, thereby sandwiching the booklet B. The surface parts of the two sandwiching members 141a and 141b are along the lateral surfaces X1 and X2 of the main body unit 110. That is, the sandwiching unit 141 holds a booklet Bin such a way that the paper surfaces of the booklet B are along the lateral surfaces X1 and X2.

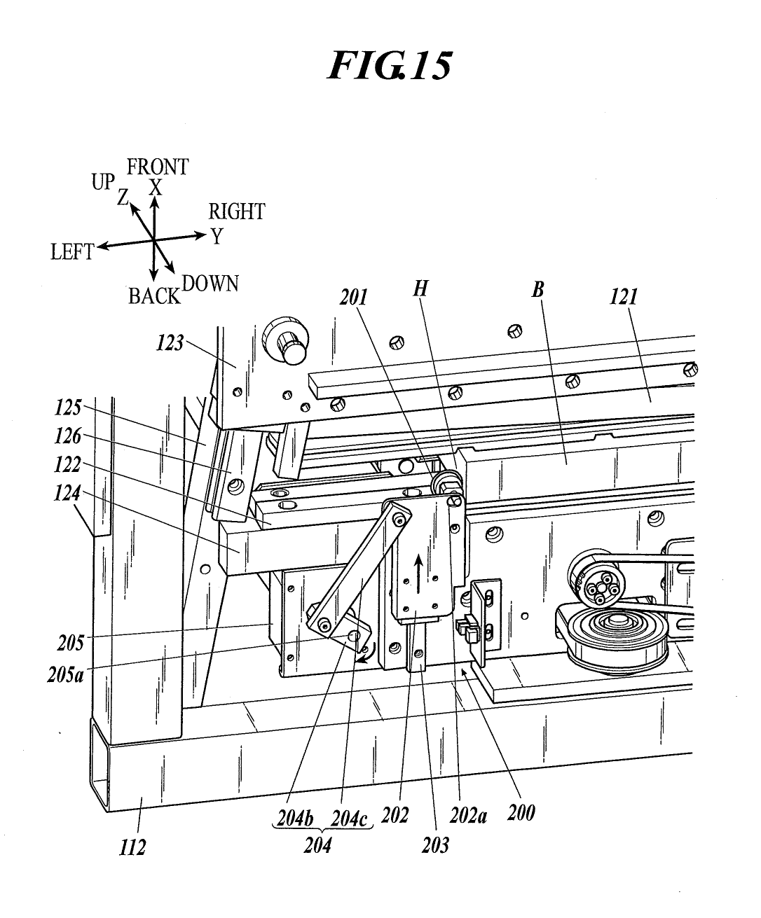

The rotation unit 142 supports the sandwiching member 141a of the sandwiching unit 141 in such a way that the sandwiching member 141a rotates. The rotation unit 142 includes a rotation drive unit 142a (shown in FIG. 14) which operates under the control of a control unit 180 (shown in FIG. 14) of the cutting device 100. The rotation unit 142 rotates the sandwiching unit 141 by drive of the rotation drive unit 142a and holds the sandwiching unit 141 at a predetermined rotation angle so as to control a rotation angle of a booklet B held by the sandwiching unit 141.

The rotation unit 142 engages with a guide rail 143a disposed, in the main body unit 110, along a direction which is at right angles to a surface direction of the bottom 112 so as to linearly move along the guide rail 143a.

The linear movement unit 143 includes the guide rail 143a, a pulley 143b, a pulley 143c, a belt 143d and a drive unit 143e (shown in FIG. 14). The pulley 143b rotates on a rotation shaft thereof fixed to the rotation unit 142. The pulley 143c is disposed on a side opposite to a delivery opening 145 for booklets B with respect to an extending direction of the guide rail 143a. The belt 143d connects the pulley 143b, the pulley 143c and the like to each other. The drive unit 143e linearly moves the rotation unit 142 along the guide rail 143a by drive of the belt 143d. The linear movement unit 143 linearly moves the rotation unit 142 so as to linearly move a booklet B held by the sandwiching unit 141 to the delivery opening 145.

As shown in FIGS. 5 to 8, the delivery opening 145 is provided on the bottom 112 side. The delivery opening 145 is provided between the blade 121 and the blade 122 of the cutting unit 120. The components of the carrier unit 140 carry a booklet B delivered from the delivery unit 32 of the carrier device 30 into the delivery opening 145, and keeps the booklet B there, thereby keeping the booklet B between the blade 121 and the blade 122. At the time, an edge part of the booklet B to be cut off by the cutting unit 120 is out of the main body unit 110 from the bottom 112 downward. In this state, the cutting unit 120 operates, and the blade 121 moves close to the blade 122, so that the edge part of the booklet B is cut off and drops down.

The carrier unit 140 linearly moves the booklet B, edge parts of which have been cut off (cutting processing), in such away that the booklet B is away from the delivery opening 145. Then, as shown in FIG. 2, the carrier unit 140 sends out the booklet B, on which the cutting processing has been performed, by using a not-shown sending-out mechanism unit.

The cutting processing performed by the cutting unit 120 includes fore-edge cutting processing and top-edge/tail-edge cutting processing. The fore-edge cutting processing is cutting processing to cut off, among the edge parts of a booklet B, an edge part of the booklet B (margins of pages constituting a booklet B), the edge part being parallel to the spine H of the booklet B. The top-edge/tail-edge cutting processing is cutting processing to cut off, among the edge parts of a booklet B, edge parts of the booklet B (margins of pages constituting a booklet B), the edge parts being at right angles to the spine H of the booklet B. There are two edge parts which are at right angles to the spine H. Hence, the top-edge/tail-edge cutting processing is performed twice by rotating a booklet B.

In the following, operations of the carrier unit 140 performed as the cutting processing is performed are described.

First, as shown in FIG. 5, the carrier unit 140 holds with the sandwiching unit 141a booklet B delivered from the delivery unit 32 of the carrier device 30. At the time, the spine H of the booklet B faces the delivery opening 145.

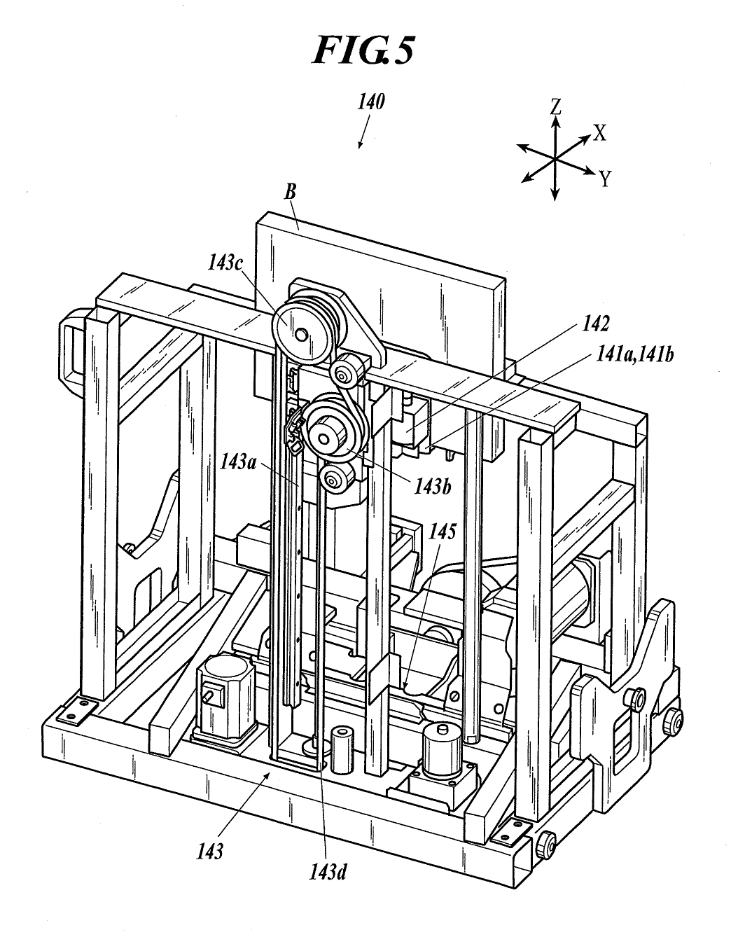

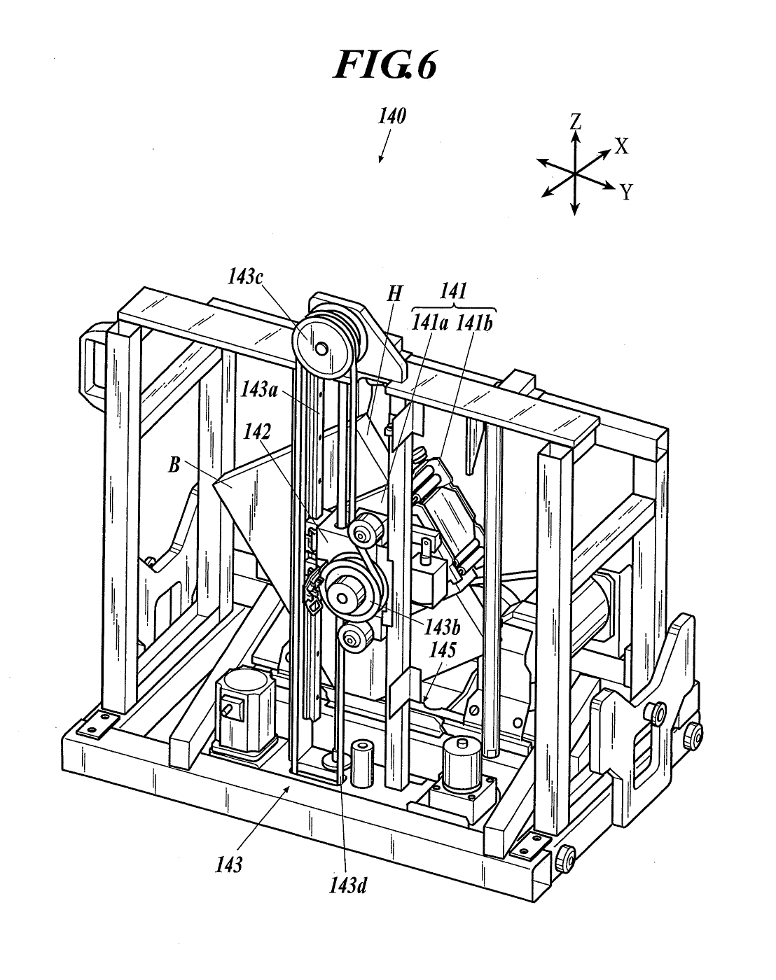

Next, the carrier unit 140 linearly moves the rotation unit 142 to the delivery opening 145 while rotating the sandwiching unit 141. Consequently, as shown in FIG. 6, the booklet B is carried to the delivery opening 145 while changing its orientation.

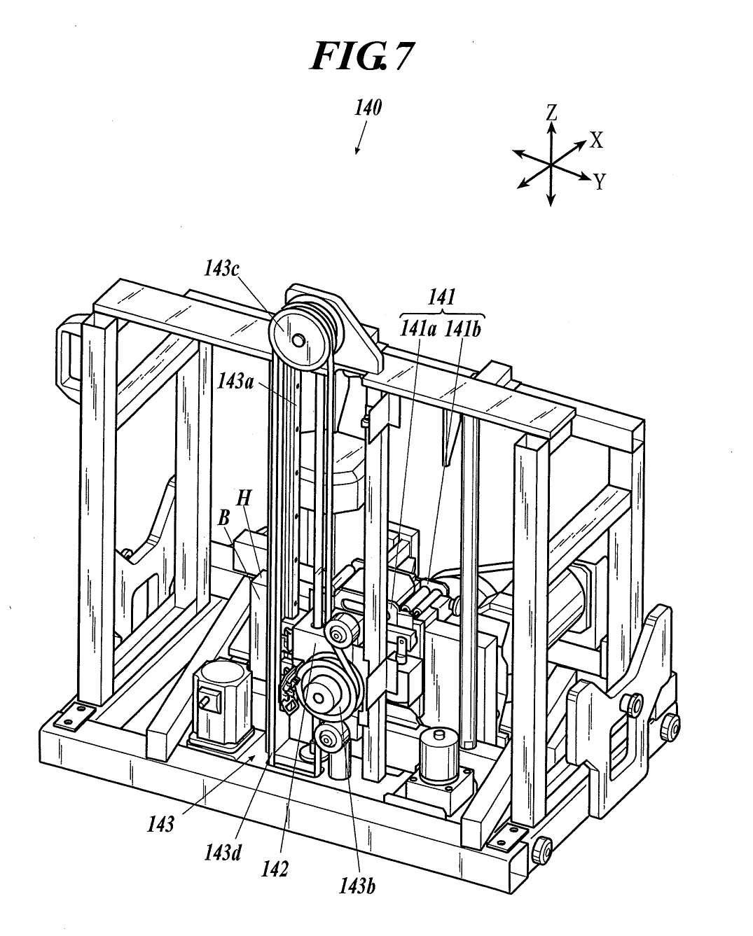

In the case of the fore-edge cutting processing, as shown in FIG. 7, the carrier unit 140 carries a booklet B into the delivery opening 145 in such a way that an edge part of the booklet B, the edge part being parallel to the spine H, faces the bottom 112.

In the case of the top-edge/tail-edge cutting processing, as shown in FIG. 8, the carrier unit 140 carries a booklet B into the delivery opening 145 in such a way that an edge part of the booklet B, the edge part being at right angles to the spine H, faces the bottom 112.

In the case of a no-booklet, such as a sheet of paper, an edge part (margin) of the sheet, the edge part being parallel to an edge part (margin) thereof positioned between the two sandwiching members 141a and 141b of the sandwiching unit 141, is cut off by the fore-edge cutting processing, and two edge parts (margins) of the sheet, the edge parts being at right angles to the edge part thereof positioned between the two sandwiching members 141a and 141b thereof, are cut off by the top-edge/tail-edge cutting processing.

In the following, the cutting processing and components related to the cutting processing are described in detail.

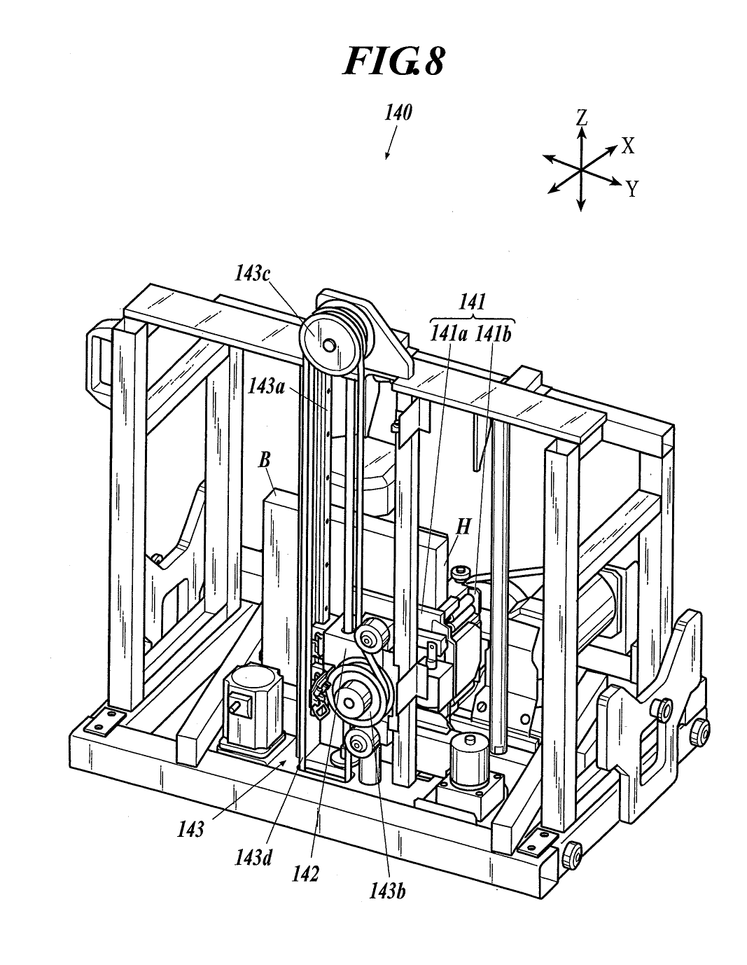

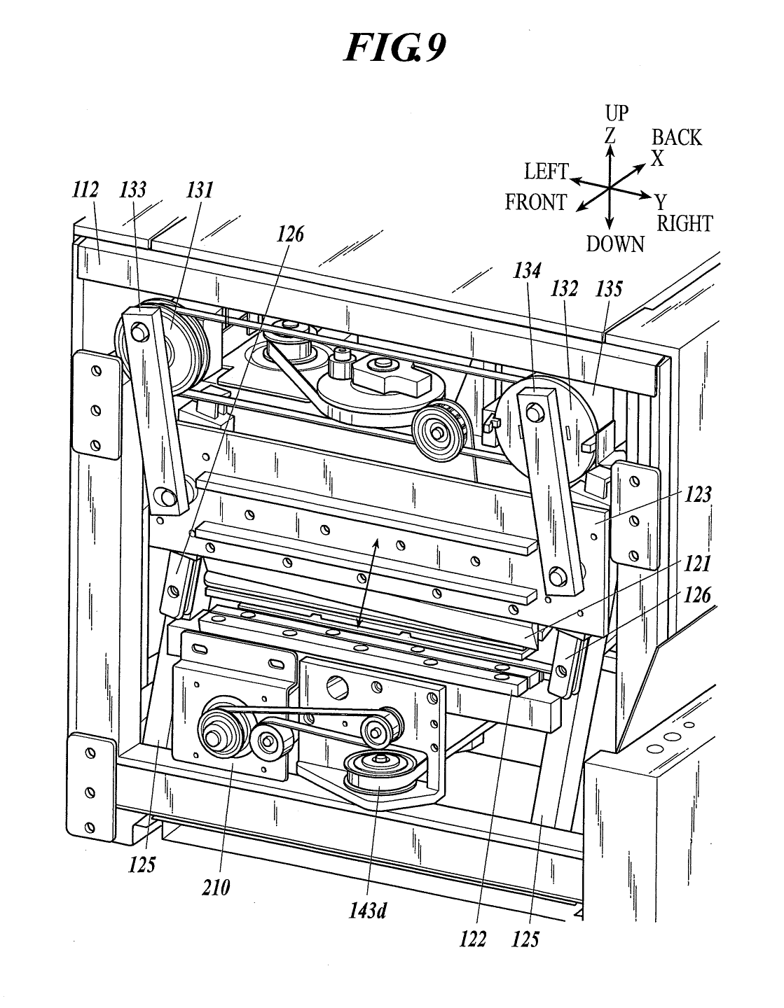

FIG. 9 is an enlarged perspective view of the cutting unit 120.

As shown in FIGS. 3, 4, 9 and the like, the blade 121 is configured in such a way that the cutting edge thereof inclines toward a paper surface of a booklet B. Consequently, the blade 121 cuts off an edge part of the booklet B in a state in which the cutting edge of the blade 121 inclines toward the paper surface of the booklet B. That is, at the cutting rotation angle, the blade 121, which is along the X-Y plane, and linearly moves between the lateral surface X1 and the lateral surface X2, is held by the holding unit 123 in such a way as to have a predetermined inclination toward the Y-Z plane, along which the paper surface of the booklet B carried by the carrier unit 140 is disposed.

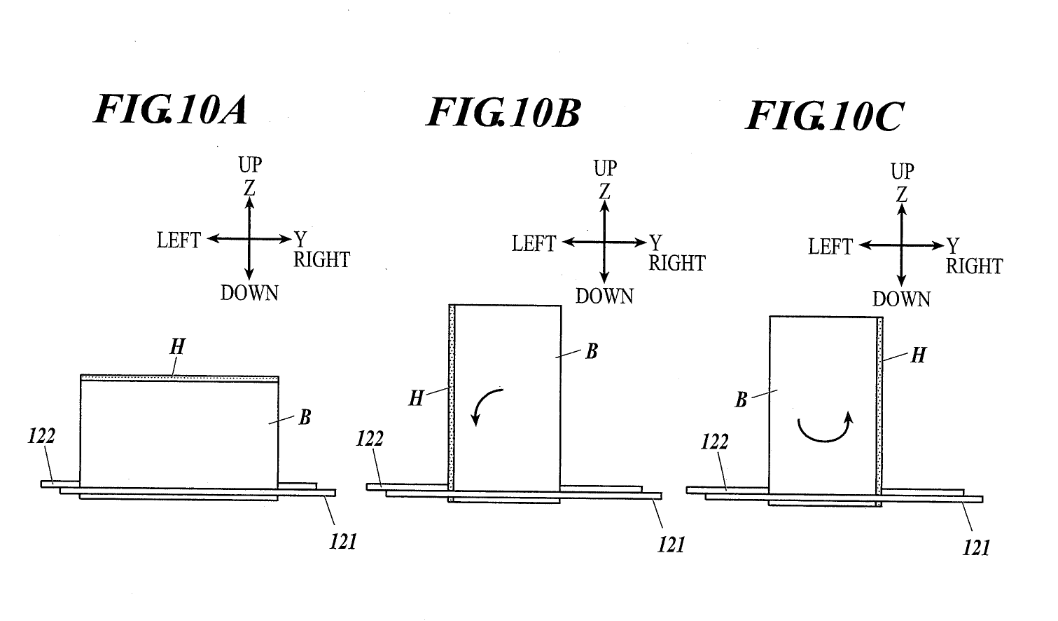

FIGS. 10A, 10B and 10C are block diagrams each showing a relationship of an orientation of a booklet B to the blade 121 in the fore-edge cutting processing or the top-edge/tail-edge cutting processing.

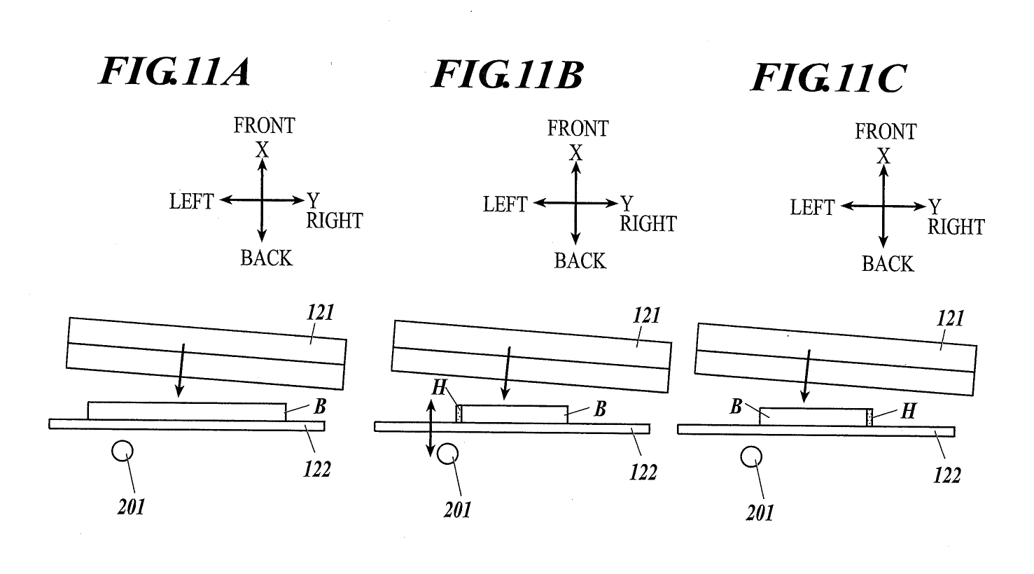

FIGS. 11A, 11B and 11C are block diagrams each showing a relationship between an inclination of the blade 121 and an orientation of the booklet B in the fore-edge cutting processing or the top-edge/tail-edge cutting processing.

FIGS. 10A and 11A show a relationship between the blade 121 and the booklet B in the fore-edge cutting processing. FIGS. 10B and 11B show a relationship between the blade 121 and the booklet B in first top-edge/tail-edge cutting processing of the top-edge/tail-edge cutting processing. The first top-edge/tail-edge cutting processing is top-edge/tail-edge cutting processing in which the blade 121 abuts a booklet B from a side opposite to the spine H of the booklet B. FIGS. 10C and 11C show a relationship between the blade 121 and the booklet B in second top-edge/tail-edge cutting processing of the top-edge/tail-edge cutting processing. The second top-edge/tail-edge cutting processing is top-edge/tail-edge cutting processing in which the blade 121 abuts a booklet B from the spine H side of the booklet B. FIGS. 10A, 10B and 10C correspond to FIGS. 11A, 11B and 11C, respectively.

The cutting processing of the embodiment is performed in the order of processing shown in FIGS. 10A, 10B and 10C. That is, the cutting processing of the embodiment is performed in the order of the fore-edge cutting processing and the top-edge/tail-edge cutting processing. The top-edge/tail-edge cutting processing of the embodiment is performed in the order of the first top-edge/tail-edge cutting processing, in which the blade 121 abuts a booklet B from the side opposite to the spine H, and the second top-edge/tail-edge cutting processing, in which the blade 121 abuts a booklet B from the spine H side of the booklet B.

The order of the processing of the cutting processing described above is not a limitation but an example, and hence can be appropriately set.

In the first top-edge/tail-edge cutting processing shown in FIG. 10B, before the blade 121 abuts the spine H of a booklet B, a round blade 201 of a pre-processing unit 200 makes a cut at a point of the spine H, the point where the blade 121 abuts the spine H, along a cutting direction in which the blade 121 cuts the spine H.

In the following, the pre-processing unit 200 is described.

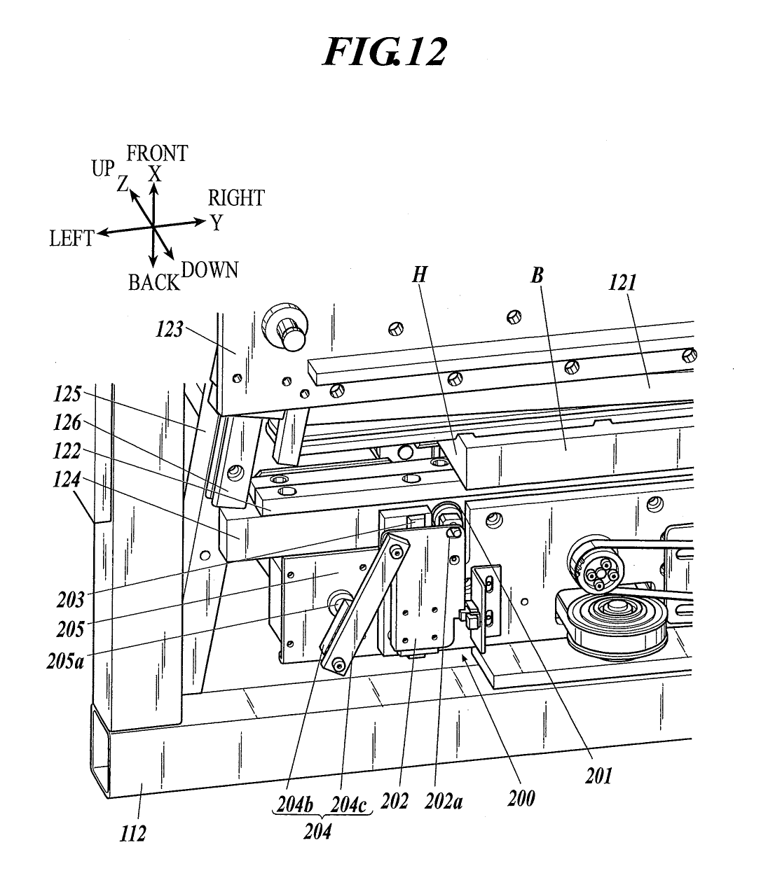

FIG. 12 is a perspective view of the pre-processing unit 200 and components around the pre-processing unit 200.

The pre-processing unit 200 includes the round blade 201, a round-blade support member 202, a guide rail 203, a crank connecting unit 204 and a rotation drive unit 205.

Note that the bottom 112 side of the pre-processing unit 200 is covered with a cover member 210 as shown in FIG. 9. However, in FIGS. 12 to 18, for convenience of explanation, the cover member 210 and components disposed on the bottom 112 side of the cover member 210 are not shown.

The round blade 201 is a disc-shaped member, and disposed in such a way that a surface of the disc-shaped member is along the bottom 112. The outer circumference of the round blade 201 is its cutting edge. The round blade 201 is provided with a rotation shaft at the center thereof. The round blade 201 is supported by the round-blade support member 202 in such a way as to freely rotate.

The round-blade support member 202 is a plate-shaped member disposed along the bottom 112. The round-blade support member 202 has a hole 202a to support the rotation shaft of the round blade 201 so that the rotation shaft freely rotates. The hole 202a is, for example, as shown in FIG. 12 and the like, an oval hole, and provided in such a way that the long axis of the oval hole 202a is approximately along the longitudinal direction of the blade 121. Momentum is given to the round blade 201 by a not-shown momentum giving member (a spring, for example) toward the spine H side in the long axis direction of the oval hole 202a.

The round-blade support member 202 is supported by the guide rail 203 in such a way as to linearly move.

The guide rail 203 supports the round-blade support member 202 in such a way that the round-blade support member 202 linearly moves along the bottom 112. More specifically, the guide rail 203 is disposed, for example, as shown in FIG. 12, in such a way as to run from the holding unit 124 for the blade 122 toward the lateral surface X2, so as to support the round-blade support member 202 in such a way that the round-blade support member 202 linearly moves along the direction being at right angles to the lateral surfaces X1 and X2.

The round-blade support member 202, which is supported by the guide rail 203 so as to linearly move, and the round blade 201, which is supported by the round-blade support member 202, reciprocate by the guide rail 203 between a point (standby point) on a side which faces the blade 121 with the delivery opening 145 in between and a point in the delivery opening 145, the point to which a part of the round-blade support member 202 and the round blade 201 move.

The crank connecting unit 204 conveys power to the round-blade support member 202 so that the round-blade support member 202 linearly moves along the guide rail 203.

More specifically, the crank connecting unit 204 is, for example, as shown in FIG. 12, connected to the round-blade support member 202 via a connecting rod 204b and a crank shaft 204c each of which rotates on a rotation shaft 205a of the rotation drive unit 205. The rotation shaft 205a is along a direction being at right angles to the bottom 112. Consequently, the crank connecting unit 204 converts the rotational movement centering on the rotation shaft 205a into linear movement along the guide rail 203 so as to convey the linear movement to the round-blade support member 202.

The crank connecting unit 204 linearly moves the round-blade support member 202 so as to handle any thickness of booklets B to be carried into the delivery opening 145.

The rotation drive unit 205 is, for example, a motor such as an electric motor, and rotates the rotation shaft 205a under the control of the control unit 180 (shown in FIG. 14).

The pre-processing unit 200 is disposed, with respect to the Y direction, on the spine H side of a booklet B which is carried into the delivery opening 145 in the first top-edge/tail-edge cutting processing, in which the blade 121 abuts a booklet B from the side opposite to the spine H of the booklet B, and configured in such a way that the outer circumference of the round blade 201, namely, its edge, abuts the spine H of the booklet B.

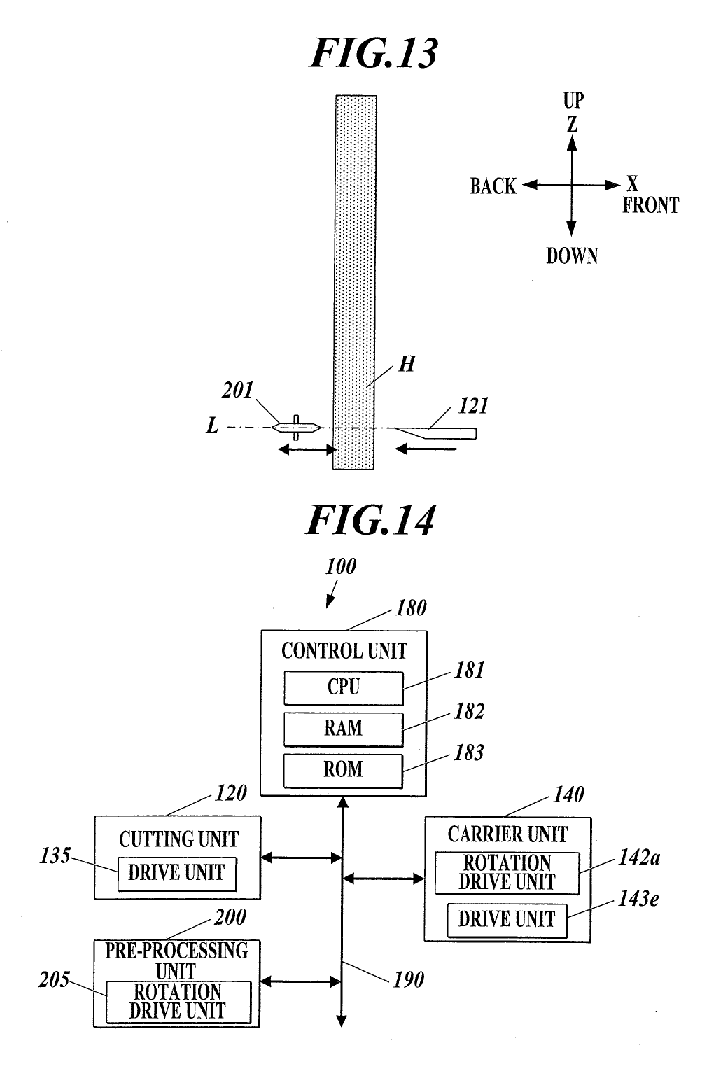

More specifically, as shown by a line L in FIG. 13, the round blade 201 makes a cut at a point of the spine H, the point where the blade 121 abuts the spine H, along the cutting direction, in which the blade 121 cuts the spine H.

FIG. 14 is a block diagram of main components related to control of operations of the cutting device 100.

As shown in FIG. 14, the cutting device 100 includes the control unit 180 which controls operations of the components (units and the like) of the cutting device 100. The control unit 180 includes a CPU 181, a RAM 182 and a ROM 183. The CPU 181 reads programs and/or data in accordance with processing contents from a storage device, such as the ROM 183, so as to perform processing in accordance with the read programs and/or data, and controls operations of the components, such as the drive unit 135, the rotation drive unit 142a, the drive unit 143e and the rotation drive unit 205, which are connected to each other and to the control unit 180 via a bus 190.

In the following, operations of the pre-processing unit 200 to make a cut on the spine H of a booklet B are described.

Until a booklet B is carried into the delivery opening 145, the pre-processing unit 200 stands by at the standby point on the side, which faces the blade 121, with the delivery opening 145 in between as shown in FIG. 12.

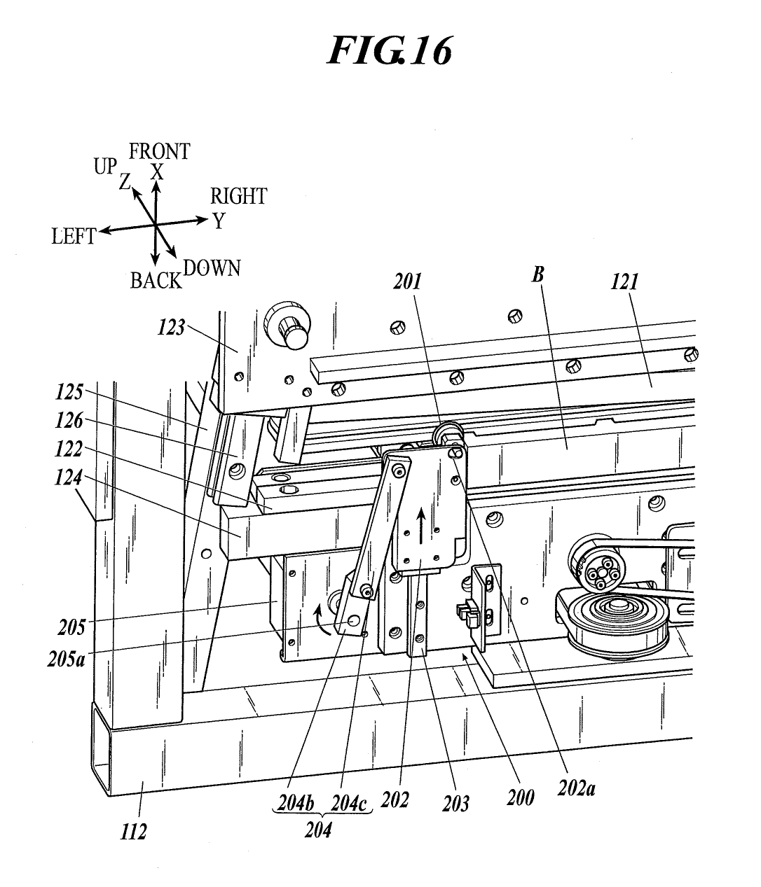

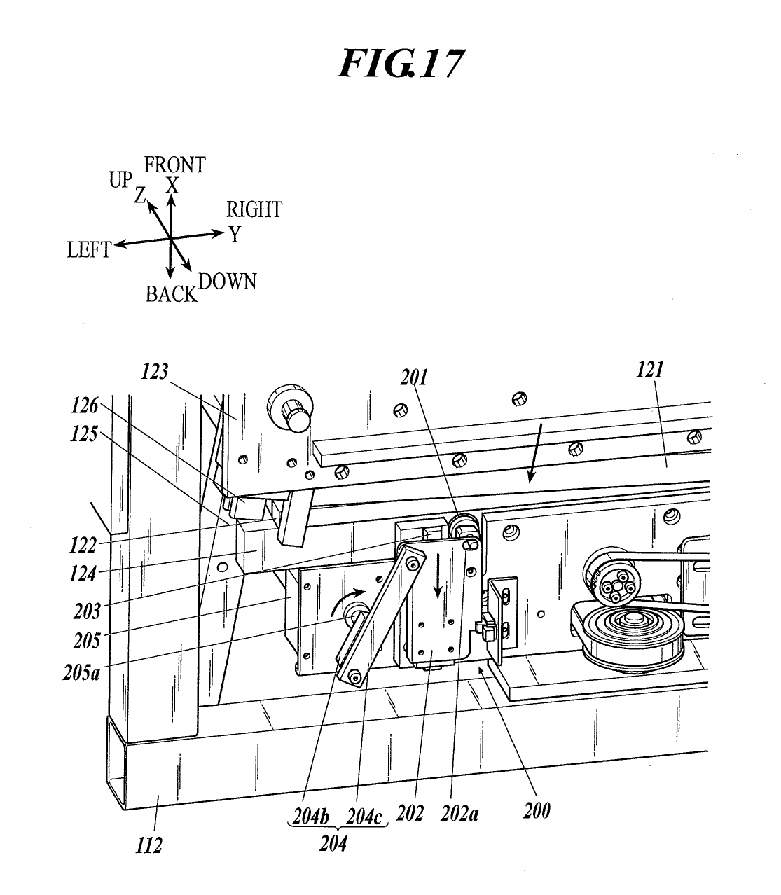

In the first top-edge/tail-edge cutting processing, in which the blade 121 abuts a booklet B from the side opposite to the spine H of the booklet B, after a booklet B is carried into the delivery opening 145, the control unit 180 drives the rotation drive unit 205 so as to linearly move the round-blade support member 202 of the pre-processing unit 200. Consequently, as shown in FIGS. 15 and 16, the round-blade support member 202 linearly moves along the guide rail 203 so as to move from the standby point toward the blade 121. At the time, the round blade 201 makes a cut on the spine H of the booklet B by rotating along the cutting direction, in which the blade 121 cuts the spine H, while abutting the spine H.

The control unit 180 drives the rotation drive unit 205, for example, in such a way that the rotate shaft 205a makes one rotation. Consequently, the round blade 201 makes a cut on the spine H of a booklet B, which is carried into the delivery opening 145, by abutting the spine H in such a way as to make one round trip in a direction being at right angles to the paper surfaces of the booklet B.

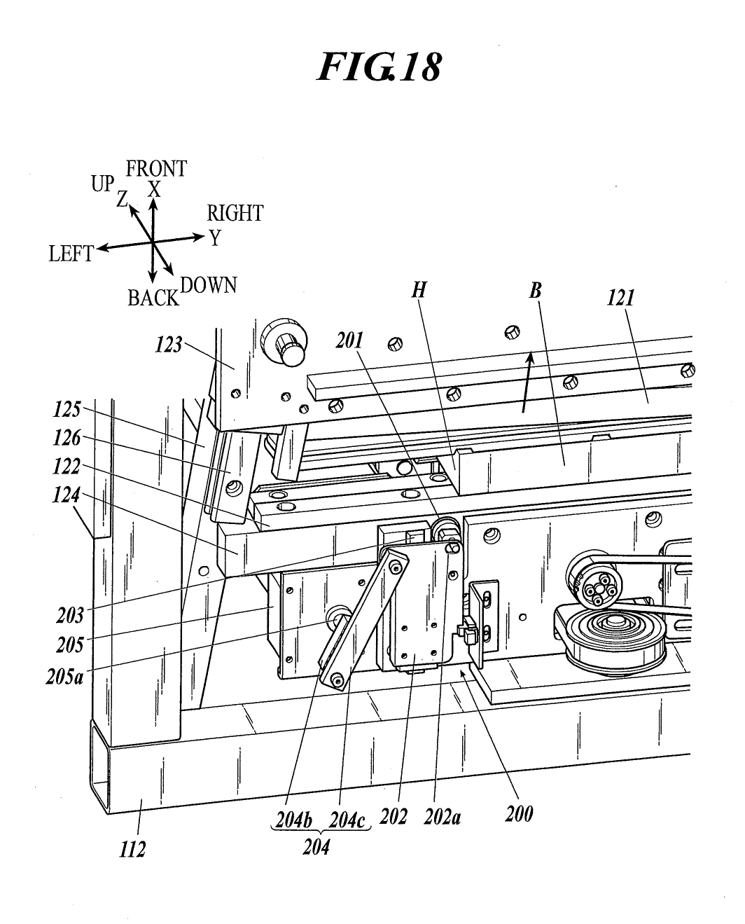

After a cut is made on the spine H by the operations of the pre-processing unit 200, the control unit 180 operates the drive unit 135 so that the blade 121 abuts the booklet B so as to cut off an edge part of the booklet B as shown in FIG. 17.

By the time, a cut has been made on the spine H, so that a pressure applied to the booklet B from the blade 121 is released via the cut. Consequently, distortion of the booklet B is prevented. Accordingly, as shown in FIG. 18, an excellent cut surface can be obtained without generating a burr on the spine H side of the cut surface.

The cut made on the spine H of a booklet B by the pre-processing unit 200 is made at a point of the spine H, the point where the blade 121 abuts the spine H, along the cutting direction, in which the blade 121 cuts the spine H. Consequently, the point where the blade 121 cuts a booklet B and the point where a cut is made are the same, and hence there is no cut left on the booklet B on which the cutting processing has been performed. Accordingly, an excellent cut surface can be obtained while the spine H is finished more beautifully.

The hole 202a is in the shape of an oval, the long axis of which is along the longitudinal direction of the blade 121. Accordingly, with respect to the Y direction, clearance for the round blade 201 to move in accordance with the position of the spine H of a booklet B can be ensured, and hence a cut can be made well in accordance with the position of the spine H, the position which may change depending on various factors, such as the thickness of a cover of the booklet B.

As described above, according to the image forming system 1 of the embodiment, in the first top-edge/tail-edge cutting processing of the top-edge/tail-edge cutting processing, before the blade 121 abuts the spine H of a booklet B, the pre-processing unit 200 makes a cut at a point of the spine H, the point where the blade 121 abuts the spine H. Accordingly, a pressure applied to the booklet B from the blade 121 can be released via the cut, and hence distortion of the booklet B can be prevented, and an excellent cut surface can be obtained without generating a burr on the spine H side of the cutting surface.

Furthermore, in the embodiment, an excellent cut surface can be obtained by making a cut on the spine H. Consequently, a step to change a direction of an inclination of a blade, which is conventionally performed, is unnecessary. Accordingly, a complicated configuration for the step and a space for the configuration as well as time for the step can be eliminated, and hence an excellent cut surface including the spine H side thereof can be obtained with a simple mechanism.

Furthermore, the pre-processing unit 200 makes a cut by using the round blade 201, which abuts the spine H of a booklet B along the cutting direction, in which the blade 121 cuts the spine H. Accordingly, the point where the blade 121 cuts the booklet B and the point where a cut is made are the same, and hence there is no cut left on the booklet B on which the cutting processing has been performed, and the spine H can be finished more beautifully.

Furthermore, the round blade 201 rotates while abutting the spine H of a booklet B along the cutting direction, in which the blade 121 cuts the spine H. Accordingly, the round blade 201, which is for making a cut, is not caught up in the spine H, and hence a cut can be made on the spine H more smoothly.

The pre-processing unit 200 makes the round blade 201 reciprocate along the cutting direction, in which the blade 121 cuts the spine H of a booklet B. Accordingly, a cut can be made on the spine H certainly. In addition, by the reciprocating movement of the round blade 201 (pre-processing unit 200) to make a cut, the pre-processing unit 200 can be automatically back to an initial point (standby point) after making a cut.

The main body unit 110 of the cutting device 100 rotates to expose the blades 121 and 122 of the cutting unit 120 on a lateral side. Accordingly, a replacement operation of the blades 121 and 122 of the cutting unit 120 disposed on the lateral side by the rotation of the main body unit 110 can be performed from the lateral side of the cutting device 100. Accordingly, the blades 121 and 122 can be more easily replaced with other blades.

Furthermore, the main body unit 110 can change the cutting rotation angle, at which an edge part of a booklet B to be cut off by the cutting unit 120 comes out of the main body unit 110 downward so as to cut off the edge part downward, and the no-cutting rotation angle, at which the blades 121 and 122 of the cutting unit 120 are exposed on a lateral side. Consequently, the blades 121 and 122 of the cutting device 100, which can easily separate an edge part to be cut off from a booklet B by dropping the edge part when the cutting processing is performed on the booklet B, can be easily replaced with other blades at the time when the cutting processing is not performed.

Furthermore, the cutting unit 120 has the two blades 121 and 122, the cutting edges of which face each other, and the main body unit 110 can change the first rotation angle, at which the cutting edge of the blade 121 faces upward, and the second rotation angle, at which the cutting edge of the blade 122 faces upward, as the no-cutting rotation angle. Accordingly, by placing the main body unit 110 at a rotation angle at which the cutting edge of one of the blades 121 and 122, the one to be replaced with another blade, faces upward, the blades 121 and 122 can be replaced with other blades more safely.

Furthermore, the first rotation angle and the second rotation angle are rotation angles to which the main body unit 110 rotates about 90 degrees from the cutting rotation angle in different directions. Accordingly, only by changing the directions to rotate the main body unit 110, a blade, the cutting edge of which faces upward, can be changed between the blades 121 and 122.

The embodiment described herein is to be considered in all respects illustrative and not limitative. The scope of the present invention is to be indicated by the appended claims, rather than by the foregoing description, and all changes which come within the meaning and range of equivalency of the claims are intended to be embraced therein.

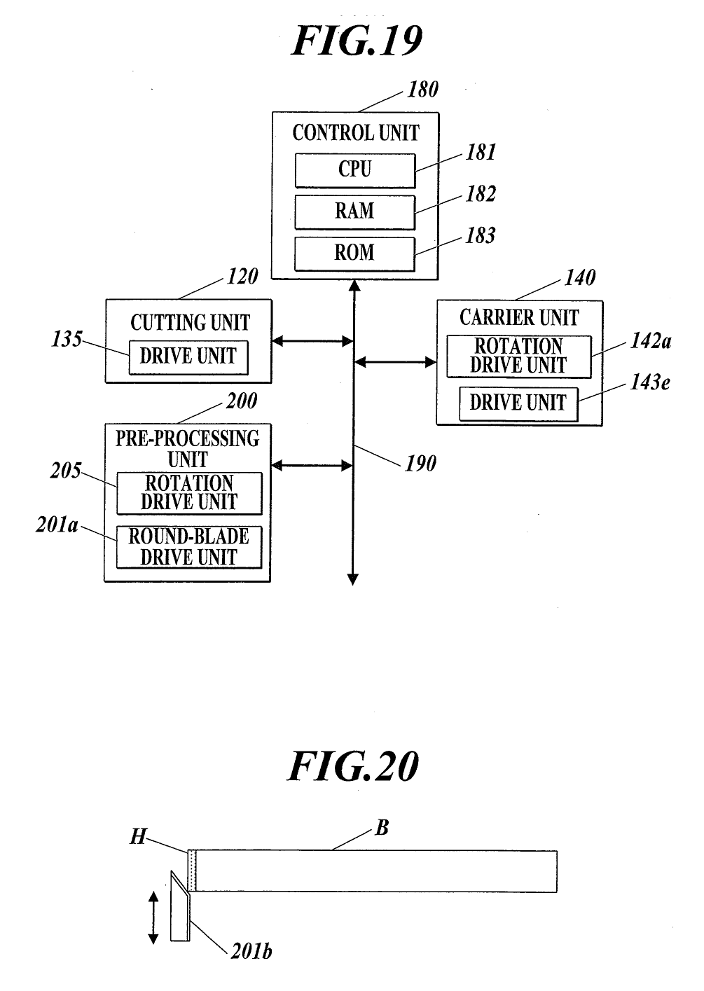

For example, in the embodiment, the round blade 201 freely rotates. However, as shown in FIG. 19, a round-blade drive unit 201a which rotates the round blade 201 may be provided so as to rotate the round blade 201 while the round blade 201 abuts the spine H.

Because the round-blade drive unit 201a rotates the round blade 201, force to make a cut on the spine H by the round blade 201 increases. Accordingly, a cut can be made on the spine H more certainly.

The depth of a cut made on the spine H should be around a depth with which a pressure applied to a booklet B by the blade 121 can be released via the cut. More specifically, for example, a cut may be deep enough to pass through a cover which is glued to a booklet B so as to cover the spine H of the booklet B, or deep enough to tear off a booklet B excellently along the cut by a pressure applied to the booklet B from the blade 121 if not deep enough to pass through the cover.

Furthermore, the pre-processing unit 200 has the round blade 201 as a blade to make a cut on the spine H. However, this is not a limitation but an example. Hence, as long as the pre-processing unit 200 can make a cut on the spine H, any configuration can be applied thereto. For example, as shown in FIG. 20, the pre-processing unit 200 may have a pointed blade 201b having a predetermined inclination toward a paper surface of a booklet B which is in the delivery opening 145, and linearly move the pointed blade 201b in such a way as to slide the pointed blade 201b on the spine H.

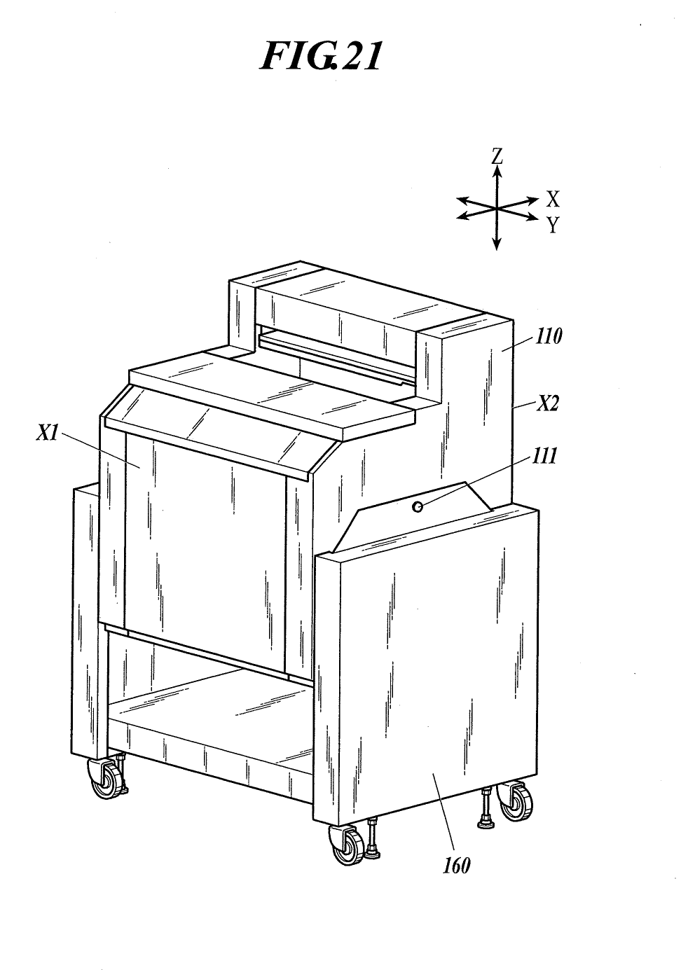

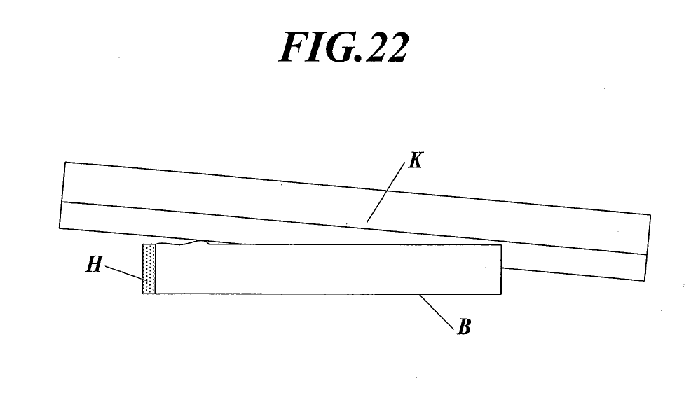

Furthermore, in the embodiment, the rotation shaft 111 of the main body unit 110 is disposed near the bottom 112. However, this is not a limitation but an example. As shown in FIG. 21, the rotation shaft 111 may be disposed at a higher position than the position thereof shown in FIG. 2. The support unit 160 supports the main body unit 110 in such a way that the main body unit 110 rotates via the rotation shaft 111 which passes through the center of gravity of the main body unit 110 or near the center of gravity thereof. Accordingly, the main body unit 110 can be supported more stably. In addition, because a weight balance of the cutting device 100 does not change depending on the change of rotation angles even when the main body unit 110 rotates, the rotation angles can be changed more stably.

Furthermore, in the embodiment, there are two rotation angles as the no-cutting rotation angle, namely, the first rotation angle and the second rotation angle. However, this is not a limitation but an example. As long as there is at least one rotation angle at which the blades 121 and 122 of the cutting unit 120 are exposed on a lateral side, the number of rotation angles as the no-cutting rotation angle is not limited.

Furthermore, it is unnecessary for the no-cutting rotation angle to be different about 90 degrees from the cutting rotation angle as long as the no-cutting rotation angle is a rotation angle at which the blades 121 and 122 can be safely replaced with other blades.

Furthermore, in the embodiment, the two blades 121 and 122 are provided. However, this is not a limitation but an example. As long as sheets of paper can be cut by one blade or a pair of blades, there is no limitation. Here, the blade (or the pair of blades) can be safely replaced with another blade by making the cutting edge of the blade, a side opposite to the cutting edge being held by a component, face upward when the blade is exposed on a lateral side by the rotation of the main body unit 110.

Furthermore, it is unnecessary that the cutting edge of a blade to be replaced with another blade faces upward as long as safety of a maintenance person who replaces the blade can be ensured. For example, the blade may be covered with a cover member, and replaced with another blade.

Furthermore, in the embodiment, the main body unit 110 is expected to be manually rotated with respect to the support unit 160. However, this is not a limitation but an example. The main body unit 110 may be rotated by power of a motor or the like. Alternatively, even in the case where the main body unit 110 is manually rotated, a mechanical component to change rotation angles, such as a lever, may be provided.

The components (units and the like) of the image forming system 1 described in the embodiment are not limitations but examples. Hence, for example, the cutting device 100 may have some or all of the components (configuration) of the carrier device 30.

This application is based upon and claims the benefit of priority under 35 USC 119 of Japanese Patent Application No. 2012-096261 filed on Apr. 20, 2012, the entire disclosure of which, including the description, claims, drawings and abstract, is incorporated herein by reference in its entirety.

What is claimed is:

1. A cutting device comprising:
a cutting unit which performs fore-edge cutting processing to cut off a first edge part of a booklet, the first edge part being parallel to a spine of the booklet, and top-edge/tail-edge cutting processing to cut off a second edge part of the booklet, the second edge part being perpendicular to the spine, in a state in which a blade inclines toward a paper surface of the booklet; and
a pre-processing unit which, in first top-edge/tail-edge cutting processing of the top-edge/tail-edge cutting processing, the first top-edge/tail-edge cutting processing in which the blade cuts the booklet from a side opposite to the spine, before the blade abuts the spine, makes a cut at a point of the spine along a cutting direction in which the blade cuts the spine, the point where the blade abuts the spine.

2. The cutting device according to claim 1, wherein the pre-processing unit includes a round blade which abuts the spine so as to make the cut on the spine.

3. The cutting device according to claim 2, wherein the round blade rotates while abutting the spine along the cutting direction.

4. The cutting device according to claim 2, wherein the pre-processing unit includes a round-blade drive unit which rotates the round blade.

5. The cutting device according to claim 1, wherein the pre-processing unit makes a blade which abuts the spine so as to make the cut on the spine reciprocate along the cutting direction.

6. The cutting device according to claim 1 further comprising a changing unit which changes an orientation of the booklet with respect to the blade so as to change the first edge part and the second edge part to be cut off by the blade depending on which of the fore-edge cutting processing and the top-edge/tail-edge cutting processing is performed.

7. An image forming system comprising:
an image forming device which performs image formation on sheets of paper;
a paper processing device which creates a booklet from the sheets; and
the cutting device according to claim 1, wherein
the cutting device cuts off the first edge part and the second edge part of the booklet created by the paper processing device.

8. The image forming system according to claim 7, wherein the pre-processing unit includes a round blade which abuts the spine so as to make the cut on the spine.

9. The image forming system according to claim 8, wherein the round blade rotates while abutting the spine along the cutting direction.

10. The image forming system according to claim 8, wherein the pre-processing unit includes a round-blade drive unit which rotates the round blade.

11. The image forming system according to claim 7, wherein the pre-processing unit makes a blade which abuts the spine so as to make the cut on the spine reciprocate along the cutting direction.

12. The image forming system according to claim 7, wherein the cutting device includes a changing unit which changes an orientation of the booklet with respect to the blade so as to change the first edge part and the second edge part to be cut off by the blade depending on which of the fore-edge cutting processing and the top-edge/tail-edge cutting processing is performed.
